(19) United States
(12) Patent Application Publication
(10) Pub. No.: US 2019/0150482 A1
(43) Pub. Date: May 23, 2019

(54) RAVIOLI ANALOGS AND METHODS FOR MAKING SUCH ANALOGS

(71) Applicant: NESTEC S.A., Vevey (CH)

(72) Inventor: Lynn Ann Gerheart, St. Louis, MO (US)

(21) Appl. No.: 16/258,066

(22) Filed: Jan. 25, 2019

Related U.S. Application Data
(63) Continuation of application No. 14/088,982, filed on Nov. 25, 2013, now abandoned.
(60) Provisional application No. 61/733,014, filed on Dec. 4, 2012.

(51) Int. Cl. A23K 40/25; A23L 7/109; A23P 30/25; A23P 20/25; A23K 50/42; A23K 50/40; A23K 40/20; A23K 20/147; A23K 10/30; A23K 10/22; A23K 10/20; A23K 20/158

(52) U.S. Cl. CPC A23K 40/25; A23L 7/11; A23P 30/25; A23P 20/25; A23K 50/42; A23K 20/158; A23K 40/20; A23K 20/147; A23K 10/30; A23K 10/22; A23K 10/20; A23K 50/40

(57) ABSTRACT

In one aspect, a ravioli analog includes a first dough that completely encases a second dough, each of the first dough and the second dough having a different colorant relative to the other dough but at least one component of the first dough and the second dough being the same. In another aspect, a method for making ravioli analogs includes co-extruding a first dough and a second dough having at least one component that is present in both the first dough and the second dough, the first dough and the second dough having different colorants relative to each other; and cutting the extruded doughs into pieces having predetermined sizes with ends sealed such that the first dough completely encases the second dough. In yet another aspect, a blended food composition includes one or more ravioli analogs and one or more other comestible ingredients.

### CROSS REFERENCE TO RELATED APPLICATIONS

This application is a Continuation of U.S. patent application Ser. No. 14/088,982 filed Nov. 25, 2013, which claims priority to U.S. Provisional Application No. 61/733,014 filed Dec. 4, 2012, the entire disclosures of which are incorporated herein by this reference.

### BACKGROUND OF THE INVENTION

### Field of the Invention

The invention relates generally to food compositions and particularly to ravioli analogs suitable for use as pet foods and methods for making such ravioli analogs.

### Description of Related Art

Existing ravioli-type technology is available in the human food industry. For example, U.S. Pat. No. 6,230,613 discloses an apparatus useful for producing ravioli. The apparatus has two pillow forming rolls having recesses, and a pair of hubs or sprockets and a belt or chain. U.S. Pat. No. 5,720,991 discloses a multi-shaped ravioli manufacturing device useful for forming different shaped raviolis. The device includes multiple uniquely outlined cutting and crimping ribs, surrounding finger ejection holes, and an extrusion die plate hand support system. U.S. Pat. No. 5,010,807 discloses a ravioli forming and filling machine that has a slide bar dispenser feeding filling material into a doughy lined cavity on die rolls.

However, the ravioli produced using known technology is pasta-based, and pasta tends to have a negative effect on palatability for pets. Also, pasta based products with a filling create problems when the filling falls out of the ravioli if the ravioli is damaged during handling when used to manufacture pet food. There is, therefore, a need for ravioli analogs that can be used in pet foods, particularly to ensure palatability and maintain the integrity of the manufacturing process.

### SUMMARY OF THE INVENTION

It is, therefore, an object of the present invention to provide ravioli analogs.

It is another object of the invention to provide methods for making ravioli analogs.

It is a further object of the invention to provide food compositions containing ravioli analogs.

It is yet another object of the invention to provide an improved pet food.

It is still another object of the present invention to provide means for communicating information about or instructions for one or more of: (1) ravioli analogs; (2) a method of making ravioli analogs; (3) a method of administering ravioli analogs to an animal; (4) describing ravioli analogs to a pet owner; (5) promoting the health or wellness of an animal; (6) combining ravioli analogs with another composition; or (7) nutritional information regarding ravioli analogs.

It is another object of the present invention to provide a package comprising a container and a ravioli analog.

One or more of these or other objects are achieved by a ravioli analog comprising a first dough that completely encases a second dough, each of the first dough and the second dough having a different colorant relative to the other dough but at least one other component of the first dough and the second dough being the same relative to each other.

Other and further objects, features, and advantages of the present invention will be readily apparent to those skilled in the art.

### BRIEF DESCRIPTION OF THE DRAWINGS

FIG. 1 is a photograph of a plurality of ravioli analogs being produced on a conveyor belt in an embodiment.

FIG. 2 is a perspective view of an embodiment of a ravioli analog.

FIG. 3 is a perspective cross-section view of the embodiment of a ravioli analog shown in FIG. 2.

FIG. 4 is a perspective view of an alternative embodiment of a ravioli analog.

FIG. 5 is a perspective cross-section view of the embodiment of a ravioli analog shown in FIG. 4.

### DETAILED DESCRIPTION OF THE INVENTION

### Definitions

The term “animal” means any animal that could benefit from or enjoy ravioli analogs, including human, avian, bovine, canine, equine, feline, hircine, lupine, murine, ovine, or porcine animals.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be one or more containers of individual ravioli analogs and optionally one or more other food compositions physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “an analog” or “a method” includes a plurality of such “compounds” or “methods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context.

The terms “comprising” or “including” are intended to include embodiments encompassed by the terms “consisting essentially of and “consisting of”. Similarly, the term “consisting essentially of is intended to include embodiments encompassed by the term “consisting of”.

All percentages expressed herein are by weight of the total weight of the composition unless expressed otherwise.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### THE INVENTION

In one aspect, the invention provides methods for making ravioli analogs. The methods comprise co-extruding a first dough and a second dough that have the same or similar components relative to each other. For example, at least one component can be present in both the first dough and the second dough. In a preferred embodiment, the first dough and the second dough have the same components except for different colorants relative to each other. The co-extruded doughs can be cut into pieces having predetermined sizes with ends sealed such that first dough completely encases the second dough.

In an embodiment, the first dough and the second dough are prepared separately before co-extrusion. For example, the first dough can be prepared by grinding meat, such as frozen meat, and emulsifying the ground meat. The ground/emulsified meat, vegetable oil and water can be mixed and heated into a slurry. Additional ingredients can be blended and then mixed with the slurry from which the first dough can be produced.

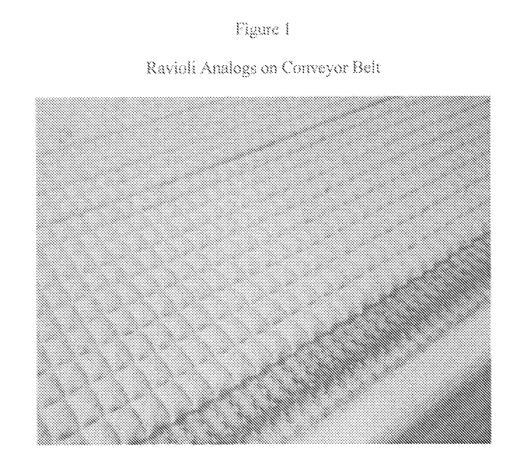

The second dough can be prepared separately in a same or similar process as the first dough, and then the first dough and the second dough can be co-extruded through a co-extrusion die to produce ropes with a center-filling of one of the doughs surrounded by the other dough. As generally illustrated in FIG. 1, the ropes can be transferred by a conveyor belt through a knife which crimps the ropes at desired lengths to produce a ravioli analog of a predetermined size.

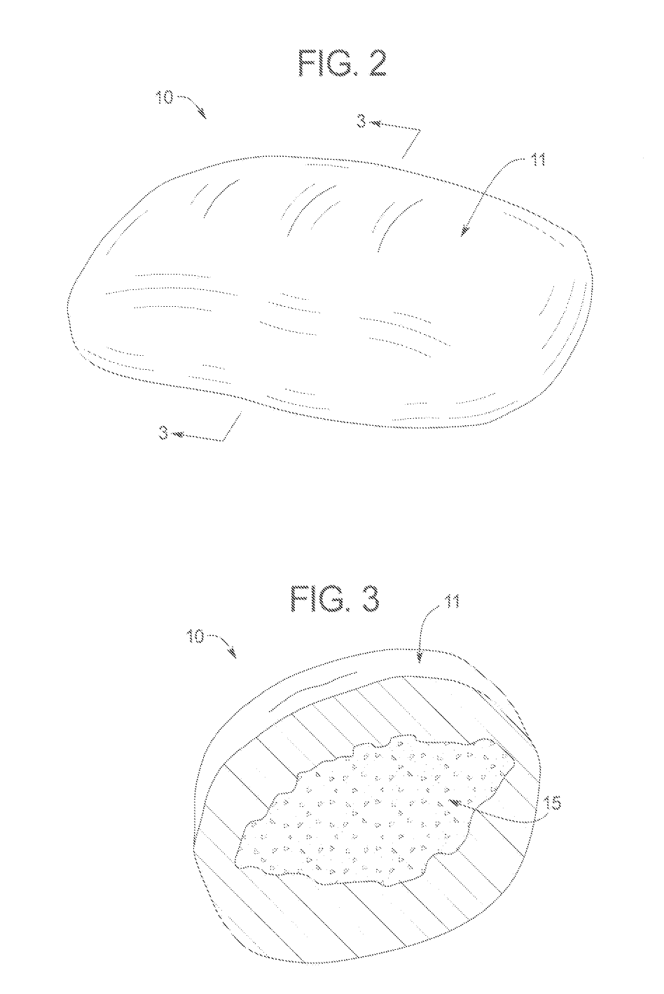

As a result, as generally illustrated in FIGS. 2 and 3, a preferred embodiment of the ravioli analog 10 comprises a first dough 11 that completely encases a second dough 15. The ravioli analog 10 can have a substantially tubular shape. The first dough 11 can form an outer layer having an interior in which the second dough 15 is positioned as a center-filling. For example, essentially all of the inner surfaces of the first dough 11 can be in contact with the second dough 15.

In an embodiment, the ravioli analogs 10 are a pet food, although the invention is not limited to pet foods. For example, the first dough 11 and the second dough 15 can be pet food compositions, such as extruded pet food compositions made using conventional extrusion or co-extrusion processes.

In some embodiments, the first dough 11 and/or the second dough 15 comprise a meat and flour. Examples of suitable flours include wheat flour, amaranth flour, bean flour, white or brown rice flour, buckwheat flour, chestnut flour, chickpea flour, potato flour, corn flour, nut flour grated from oily nuts, pea flour, peanut flour, rye flour, tapioca flour, soy flour and the like. The invention is not limited to a specific flour, and any flour known to the skilled artisan for making a dough can be used.

Meats can be any suitable meat such as poultry, beef, pork, lamb and fish, especially those types of meats suitable for pets. The meat can include any additional parts of an animal including offal. Additionally or alternatively, vegetable protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like. If flour is used, it will also provide some protein. Therefore, a material can be used that is both a vegetable protein and a flour.

The first dough 11 and/or the second dough 15 can further comprise vegetable oil, a flavorant, a colorant and water. Suitable vegetable oils include soybean oil, corn oil, cottonseed oil, sunflower oil, canola oil, peanut oil, safflower oil, and the like. Examples of suitable flavorants include yeast, tallow, rendered animal meals (e.g., poultry, beef, lamb, pork), flavor extracts or blends (e.g., grilled beef), and the like. Suitable colorants include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; iron oxides and any suitable food colorant known to the skilled artisan.

The first dough 11 and/or the second dough 15 can optionally include additional ingredients, such as other grains and/or other starches in addition to the flour, amino acids, fibers, sugars, animal oils, aromas, other oils in addition to any vegetable oil, humectants, preservatives, polyols, salts, oral care ingredients, antioxidants, vitamins, minerals, probiotic microorganisms, bioactive molecules or combinations thereof.

Suitable starches include a grain such as corn, rice, wheat, barley, oats, soy and the like, and mixtures of these grains, and can be included at least partially in the flour. Suitable humectants include salt, sugars, propylene glycol and polyhydric glycols such as glycerin and sorbitol, and the like. Examples of preservatives that can be used include potassium sorbate, sorbic acid, methyl para-hydroxybenzoate, calcium propionate and propionic acid.

Suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Examples of suitable antioxidants include butylated hydroxyanisole (“BHA”) and butylated hydroxytoluene (“BHT”), vitamin E (tocopherols), and the like. Examples of vitamins that can be used include Vitamins A, B-complex (such as B-1, B-2, B-6 and B-12), C, D, E and K, niacin and acid vitamins such as pantothenic acid and folic acid and biotin. Suitable minerals include calcium, iron, zinc, magnesium, iodine, copper, phosphorus, manganese, potassium, chromium, molybdenum, selenium, nickel, tin, silicon, vanadium, boron and the like.

Specific amounts for each additional ingredient will depend on a variety of factors such as the ingredient included in the dough; the species of animal; the animal's age, body weight, general health, sex, and diet; the animal's consumption rate; the purpose for which the ravioli analog is administered to the animal; and the like. Therefore, the component and ingredient amounts may vary widely.

In one embodiment, the ravioli analogs are dried to contain from about 6 to about 12% moisture and used as a food for animals, particularly pets such as dogs and cats. In further embodiment, the dried ravioli analog is coated with 0.5 to 10% palatants. Examples of palatants include, but are not limited to, animal fats, animal or plant hydrolysates, yeast, salts such as pyrophosphates, sugars, amino acids, or a combination.

In an embodiment, the first dough 11 and/or the second dough 15 can comprise 30 to 50%, preferably 35 to 45%, and most preferably about 42% meat by weight of the dough; 0.1 to 1%, preferably 0.3 to 0.7%, and most preferably about 0.5% vegetable oil by weight of the dough; 30 to 60%, preferably 40 to 50%, and most preferably about 45% flour by weight of the dough; 1 to 10%, preferably 3 to 7%, and most preferably about 5% gluten by weight of the dough; 1.5 to 2.5%, preferably 1.7 to 2.3%, and most preferably about 2% vitamins and minerals by weight of the dough; 0.05 to 5%, preferably 0.1 to 3%, and most preferably about 1% flavorant by weight of the dough; 0.05 to 5%, preferably 0.1 to 3%, and most preferably about 1% colorant by weight of the dough; and 0 to 10%, preferably 1 to 8%, and most preferably about 3% water by weight of the dough.

As a result, an embodiment of the invention provides a method for making ravioli analogs comprising co-extruding a first dough and a second dough having at least one component that is present in both the first dough and the second dough, the first dough and the second dough having different colorants relative to each other; and cutting the co-extruded Boughs into pieces having predetermined sizes with ends sealed such that the first dough completely encases the second dough. The first dough and the second dough can have the same components relative to each other except for the different colorants. The method can comprise preparing the first dough separately from the second dough before co-extrusion, although the second dough can be prepared in a process that has the same steps as preparation of the first dough.

In an embodiment, the first dough is prepared by grinding meat, emulsifying the ground meat, and mixing the ground and emulsified meat with vegetable oil and water. The mixture of the ground and emulsified meat, the vegetable oil and the water can be heated into a slurry, and flour can be mixed with the slurry to form the first dough. The method can include mixing additional ingredients with the flour and the slurry, the additional ingredients selected from the group consisting of grains, starches, amino acids, fibers, sugars, animal oils, aromas, colorants, other oils, humectants, preservatives, polyols, salts, oral care ingredients, antioxidants, vitamins, minerals, probiotic microorganisms, bioactive molecules and combinations thereof. In an embodiment, the co-extrusion can produce ropes having a center-filling of the second dough surrounded by the first dough, the pieces formed by a knife which crimps the ropes at predetermined lengths.

In a further aspect, the invention provides ravioli analogs made according to the methods of the invention. For example, the invention can provide a ravioli analog comprising a first dough that completely encases a second dough, each of the first dough and the second dough having a different colorant relative to the other dough but at least one component of the first dough and the second dough being the same relative to each other. In an embodiment, the components of the first dough and the second dough are the same relative to each other except for the different colorant. The first dough and the second dough can comprise at least one of poultry, beef, pork, lamb or fish. In an embodiment, the first dough and the second dough comprise wheat flour. The first dough and the second dough can comprise gluten and/or vegetable oil. In an embodiment, the ravioli analog is a pet food.

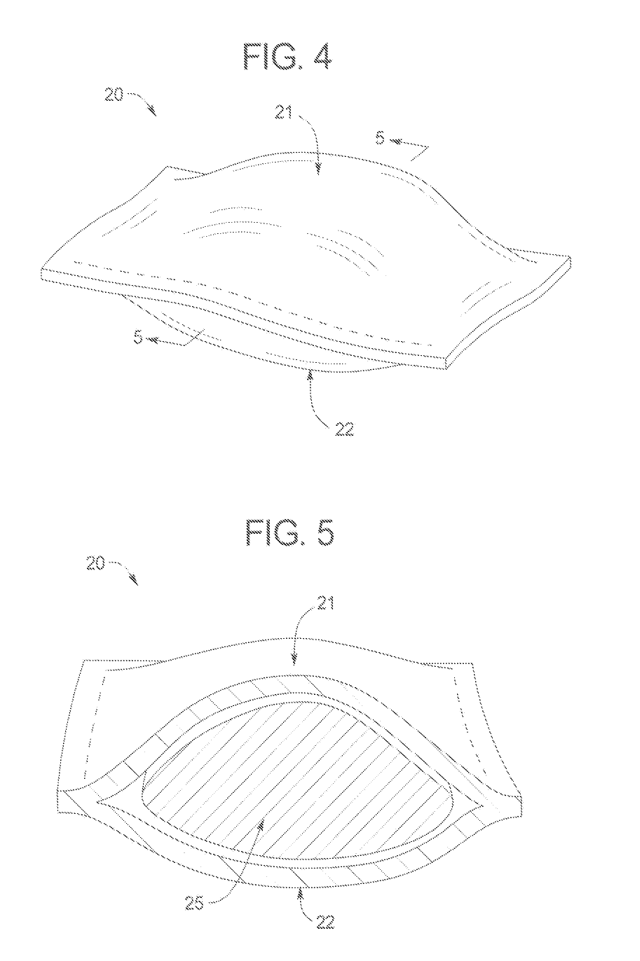

In an alternative embodiment generally illustrated in FIGS. 4 and 5, ravioli analogs 20 comprise a top layer 21, a bottom layer 22, and a center-filling 25 positioned therebetween. The top layer 21 and/or the bottom layer 22 can be the first dough, and the center-filling 25 can be the second dough. Each of the ravioli analogs 20 can be any shape, such as circular, rectangular or triangular. In an embodiment, each of the ravioli analogs 20 has a square shape. The top layer 21 is connected to the bottom layer 22 on at least one side of the ravioli analog 20 and can be connected to the bottom layer 22 at all sides of each ravioli analog 20 to completely encase the center-filling 25 between the top layer 21 and the bottom layer 22. For example, the top layer 21 can be integral with the bottom layer 22 at the entirety of the perimeter of the ravioli analog 20. Accordingly, in an embodiment where each of the ravioli analogs 20 has a rectangular or square shape, the top layer 21 can be connected to the bottom layer 22 on all four sides of each ravioli analog 20.

In an embodiment, the center-filling 25 comprises the majority of the area between the top layer 11 and the bottom layer 22. For example, the size of the center-filling 25 can be approximately equal to the area between the top layer 21 and the bottom layer 22. In an embodiment, the majority of the bottom surface of the top layer 21 and the majority of the top surface of the bottom layer 22 are in contact with the center-filling 25. For example, essentially all of the bottom surface of the top layer 21 and essentially all of the top surface of the bottom layer 22 can be in contact with the center-filling 25.

The top layer 21 and/or the bottom layer 22 can be a first edible composition; in a preferred embodiment, the top layer 21 and the bottom layer 22 are the same edible composition. The center-filling 25 can be a second edible composition. In a preferred embodiment, the second edible composition has the same or similar components as the first edible composition, has a different colorant relative to the first edible composition, and is prepared separately from the first edible composition. For example, the first edible composition and the second edible composition can be the first dough and the second dough described herein, respectively.

In another aspect, the invention provides a blended food composition containing ravioli analogs. The composition comprises one or more ravioli analogs disclosed herein or produced according to the methods disclosed herein, and one or more other comestible ingredients. The other comestible ingredients are any ingredient compatible with the ravioli analogs, preferably a blend that meets the nutritional and palatability requirements of the animal intended to consume the compositions. In various embodiments, the blended food composition comprises from about 10 to about 90% ravioli analogs and from about 90 to about 10% other comestible ingredients. In one embodiment, the blended food compositions are formulated to provide “complete and balanced” nutrition for a companion animal according to AAFCO standards. In a preferred embodiment, the blended food compositions comprise one or more ravioli analogs and one or more comestible ingredients suitable for manufacturing a dry, semi-moist, or wet pet food.

For example, 10 to 90%, more preferably 15 to 60%, and most preferably 20 to 30% of ravioli analogs dried to 6 to 12% are blended with 90 to 10%, more preferably 85 to 40%, most preferably with 80 to 70% standard dry pet food kibbles to produce a dry pet food.

For example, the blended food composition can comprise ravioli analogs, a liquid such as a sauce or a gravy, and pet food chunks that are a plurality of separate food bodies. For example, meat or fish chunks, meat or fish analog chunks, texturized vegetable protein chunks, or combinations thereof. The gravy can contain lipids, can be calorie dense and can be a hydrocolloid or gum-based solution or be aqueous. In an embodiment, the gravy contains one or more of water, starch, dextrose, glycine or an ingredient that adds flavor and aroma. In another embodiment, pieces of real vegetable, grains, herbs or combination thereof are added to the gravy as condiments.

In one embodiment, the blended food composition can comprise 45 to 70%, preferably 50 to 65%, and most preferably about 57% gravy by weight of the composition; 10 to 45%, preferably 15 to 40%, and most preferably about 33% chunks by weight of the composition; and 1 to 20%, preferably 5 to 15%, and most preferably about 10% ravioli analogs by weight of the composition.

As a result, an embodiment of the invention provides a blended food composition comprising one or more ravioli analogs comprising a first dough that completely encases a second dough, each of the first dough and the second dough having a different colorant relative to the other dough but at least one component of the first dough and the second dough being the same relative to each other, the blended food composition further comprising one or more other comestible food ingredients. For example, the comestible food ingredients can comprise gravy and/or chunks.

In another aspect, the invention provides methods for making blended food compositions. The method can comprise mixing any of the embodiments of ravioli analogs disclosed herein with one or more other comestible food ingredients, such as gravy and/or chunks. The mixture can be filled into cans, and then the cans can be covered, hermetically sealed, retorted, and then cooled to ambient temperature.

In yet another aspect, the invention provides an improved pet food. The improved pet food can comprise one or more ravioli analogs disclosed herein or produced according to the methods disclosed herein. In an embodiment, the improved pet food comprises a blended food composition that comprises the ravioli analogs and one or more other comestible food ingredients.

In a further aspect, the invention provides a method of promoting the health or wellness of an animal comprising administering ravioli analogs to the animal. In an embodiment, the animal is a pet, such as a dog or cat, for example. The method can comprise administering any embodiments of the ravioli analogs disclosed herein. Furthermore, the ravioli analogs can be administered to the animal as a blended food composition comprising the ravioli analogs and one or more other comestible food ingredients.

In another aspect, the invention provides packages useful for containing one or more ravioli analogs of the invention. The packages comprise at least one material suitable for containing the ravioli analogs and a label affixed to the material containing a word or words, picture, design, acronym, slogan, phrase, or other device, or combination thereof, that indicates that the package contains the ravioli analogs and/or the blended food compositions. Typically, such device comprises the words “highly digestible” or “highly digestible hydrolyzed protein” or an equivalent expression printed on the material. The package can comprise indicia describing a ravioli analog and/or a blended food composition comprising a ravioli analog. The package can comprise a ravioli analog inside a container and/or can comprise a blended food composition comprising a ravioli analog inside a container.

Any package configuration and packaging material suitable for containing the ravioli analogs are useful in the invention, e.g., a bag, box, sachet, bottle, can, pouch, and the like manufactured from paper, plastic, foil, metal, and the like. In preferred embodiments, the package further comprises one or more blended food compositions comprising ravioli analogs. In various embodiments, the package further comprises at least one window that permits the package contents to be viewed without opening the package. In some embodiments, the window is a transparent portion of the packaging material. In others, the window is a missing portion of the packaging material. The package can be a single package or a virtual package.

In another aspect, the invention provides a means for communicating information about or instructions for one or more of (1) a ravioli analog; (2) a method of making a ravioli analog; (3) a method of administering the ravioli analog to an animal; (4) describing the ravioli analog to a pet owner; (5) promoting the health or wellness of an animal; (6) combining the ravioli analog with another composition; or (7) nutritional information regarding the ravioli analog. Useful instructions can include feeding amounts and frequency.

The communication means is useful for instructing on the benefits of using the present invention and communicating the approved methods for feeding the ravioli analogs to an animal. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, the invention provides multi-pack packages comprising 1) a plurality of containers arranged in an array, each of the plurality of containers comprising a food composition comprising a ravioli analog, and 2) one or more devices for retaining the containers in the array. In various embodiments, the devices are boxes made from paper, plastic, polymers, or a combination thereof. In others, the devices are systems of connected plastic rings affixed to each of the containers. In still others, the devices are wrappings of plastic of similar materials, e.g., a plurality of cans stacked in an array and wrapped in plastic. In some embodiments, the multi-pack packages have one or more handles affixed to the multi-pack packages to facilitate handling and transporting the multi-pack packages.

In other embodiments, the devices further comprise one or more windows that permit the package contents to be viewed without opening the multi-pack package. In some embodiments, the windows are a transparent portion of the devices. In others, the windows are missing portions of the devices that permit the containers to be viewed without opening the multi-pack package.

In preferred embodiments, the multi-pack packages further comprise one or more indicia describing the contents of the containers in the packages. The indicia can be in the form of labels, printing on the packages, stickers, and the like and include words, symbols, pictures, photographs, figures, or combinations thereof to provide detail or examples of the ravioli analog. In a preferred embodiment, a label is affixed to the multi-pack packages containing a word or words, picture, design, acronym, slogan, phrase, or other device, or combination thereof, that indicates that the contents of the package contain a ravioli analog.

### EXAMPLES

The invention can be further illustrated by the following examples, although it will be understood that these examples are included merely for purposes of illustration and are not intended to limit the scope of the invention unless otherwise specifically indicated.

### Example 1

A 100-pound batch of dough was made by grinding frozen meats shown in Table 1 through a ⅜″ die plate, using a Weiler grinder, and emulsifying through a Karl Schnell emulsifier. Ground/emulsified meats, vegetable oil and water were mixed in a Slurry Tank and heated by steam injection to a temperature of 185° F. All remaining dry ingredients shown in Table 1 were blended in a Ribbon Mixer for 1 minute. Blended dry ingredients and meat slurry were added to a Dough Mixer and mixed for 8-12 minutes. Meat Dough was transferred from Dough Mixer to Dough Chopper to produce a meat dough for use in producing a ravioli analog.

TABLE 1
Meat Dough (Color #1)

| INGREDIENTS | lbs |
|---|---|
| Meats | 42.400 |
| Vegetable Oil | 0.500 |
| Wheat Flour | 45.276 |
| Wheat Gluten | 5.000 |
| Vitamins & Minerals | 1.944 |
| Flavor | 0.880 |
| Color #1(Titanium Dioxide) | 1.000 |
| Water | 3.000 |
| TOTAL | 100.000 |

### Example 2

A Meat Dough Color #2 prepared using the procedures given in Example 1 using ingredients shown in Table 2 to produce a meat dough for use in producing a ravioli analog.

TABLE 2
Meat Dough (Color #2)

| INGREDIENTS | lbs |
|---|---|
| Meats | 42.400 |
| Vegetable Oil | 0.500 |
| Wheat Flour | 45.276 |
| Wheat Gluten | 5.000 |
| Vitamins & Minerals | 1.944 |
| Flavor | 0.880 |
| Color #2 (Caramel) | 1.000 |
| Water | 3.000 |
| TOTAL | 100.000 |

### Example 3

### Co-Extrusion of Meat Doughs (Color #1 and Color #2)

Meat Doughs from Example 1 and Example 2 were transferred to separate hoppers with co-rotating rolls feeding a Bepex-Hutt extruder. The hoppers have the capability to heat or re-heat the dough via water jacket. Doughs are forced through a co-extrusion die which produces ropes with center-filling of meat dough (color #2) surrounded by meat dough (color #1). Ropes were transferred via a belt (FIG. 1) through a blunt-edged guillotine knife which crimps the ropes at desired lengths to produce a ravioli analog of approximately 1.18″×0.75″ (3 cmm×1.9 cm) and a moisture of approximately 35%-40%.

### Example 4

Ravioli Analogs from Example 3 were heat-set using hot water (200° F. for 2 minutes) and transferred to final mixer of standard pet food chunks and gravy using the amounts shown in Table 3. The chunks/gravy/ravioli analog mix was filled into cans (5.5 ounce capacity—307×109.3). Each can contained 154 grams of the mix. The cans were covered and hermetically sealed. They were then retorted at 254° F. for 51 minutes then cooled to ambient temperature.

TABLE 3
High Moisture Product Containing Ravioli Analog

| INGREDIENTS | lbs |
|---|---|
| Gravy | 57.000 |
| Chunks | 33.000 |
| Ravioli Analog | 10.000 |
| TOTAL | 100.000 |

### Example 5

Dried Ravioli Analog

Ravioli Analog from Example 3 were dried by first running through an APV oven for 25 minutes @ 500° F. (Oven exit moisture target 15%) and then through a dryer for 36 minutes @ 300° F. (Dryer exit moisture target 8%). Ravioli Analog at 8% moisture and <0.60 Aw are shelf stable. The Dried Ravioli Analog pieces were fed as a treat to both dogs and cats.

### Example 6

TABLE 4
High Moisture Product Containing Dried Ravioli Analog

| INGREDIENTS | lbs |
|---|---|
| Gravy | 70.000 |
| Ravioli Analog | 30.000 |
| TOTAL | 100.000 |

Dried Ravioli Analog from Example 5 was added to Gravy per Table 4. The gravy/ravioli analog mixture was filled into cans (13.2 ounce capacity—300×315.6). Each can contained 374 grams of the mixture. The cans were covered and hermetically sealed. They were then retorted at 256° F. for 75 minutes then cooled to ambient temperature.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

1: A method for making ravioli analogs, the method comprising:
preparing a first dough;
preparing a second dough separately from the first dough, at least one component is present in both the first dough and the second dough, the first dough and the second dough having different colorants relative to each other;
co-extruding the first dough and the second dough through a co-extrusion die to produce co-extruded doughs in which the first dough forms an outer layer having an interior in which the second dough is positioned as a center-filling;
cutting the co-extruded doughs into pieces having a top layer and a bottom layer, wherein the top layer in each of the pieces is connected to the bottom layer on at least one side of the piece, and the center-filling comprises a majority of the area between the top layer and the bottom layer; and
drying the pieces in an oven to form the ravioli analogs.

2: The method of claim 1 wherein the first dough and the second dough have the same components relative to each other except for the different colorants.

3: The method of claim 1 wherein the first dough is prepared by grinding meat, emulsifying the ground meat in an emulsifier apparatus, and mixing the ground and emulsified meat with vegetable oil and water.

4: The method of claim 3 comprising heating the mixture of the ground and emulsified meat, the vegetable oil and the water into a slurry.

5: The method of claim 4, wherein the heating of the mixture comprises steam injection.

6: The method of claim 4 comprising mixing the slurry with dry ingredients comprising flour to form the first dough.

7: The method of claim 6 comprising mixing additional ingredients with the flour and the slurry, the additional ingredients selected from the group consisting of grains, starches, amino acids, fibers, sugars, animal oils, aromas, colorants, other oils, humectants, preservatives, polyols, salts, oral care ingredients, antioxidants, vitamins, minerals, probiotic microorganisms, bioactive molecules and combinations thereof.

8: The method of claim 1 wherein the first dough and the second dough each comprise wheat gluten, wheat flour, poultry meal, and sunflower oil; and the second dough further comprises iron oxide.

9: The method of claim 6, wherein:
the mixing of the ground and emulsified meat with the vegetable oil and the water, and the heating of the mixture into the slurry, are both performed in a tank;
the method comprises transferring the slurry from the tank to a mixer; and
the mixing of the slurry with the dry ingredients is performed in the mixer for 8-12 minutes.

10: The method of claim 9 comprising transferring the first dough from the mixer to a dough chopper and then to a hopper comprising a water jacket configured to apply heat to the dough before the co-extruding of the first dough and the second dough.

11: The method of claim 1 wherein the first dough comprises 30% to 50% meat by weight of the first dough, 0.1% to 1% vegetable oil by weight of the first dough; 30% to 60% flour by weight of the first dough; 1% to 10% gluten by weight of the first dough; and 1% to 8% water by weight of the dough.

12: The method of claim 11 wherein the first dough consists of the meat, the vegetable oil, the flour, the gluten, the water, a colorant, vitamins and minerals, and a flavorant.

13: The method of claim 1 wherein the second dough comprises 30% to 50% meat by weight of the second dough, 0.1% to 1% vegetable oil by weight of the second dough; 30% to 60% flour by weight of the second dough; 1% to 10% gluten by weight of the second dough; and 1% to 8% water by weight of the dough.

14: The method of claim 13 wherein the second dough consists of the meat, the vegetable oil, the flour, the gluten, the water, a colorant, vitamins and minerals, and a flavorant.

15: The method of claim 1 wherein, in each of the pieces, essentially all of the inner surfaces of the first dough contact the second dough, and the first dough completely encases the second dough.

16: The method of claim 1 wherein the first dough comprises 35% to 45% of meat by weight of the first dough, 0.3% to 0.7% vegetable oil by weight of the first dough, 40% to 50% flour by weight of the first dough, and 3% to 7% of gluten by weight of the first dough.

17: The method of claim 1 wherein the second dough comprises 35% to 45% of the meat by weight of the second dough, 0.3% to 0.7% of the vegetable oil by weight of the second dough, 40% to 50% of the flour by weight of the second dough, and 3% to 7% of the gluten by weight of the second dough.

18: The method of claim 1 wherein the first dough that forms the outer layer does not contain any fiber.

19: The method of claim 1 wherein the ravioli analogs made by the drying have 6 to 12% moisture.

20: The method of claim 19, further comprising:
forming a blended food composition comprising the ravioli analogs, meat or fish chunks, and a gravy;
filling the blended food composition into cans;
covering the filled cans;
hermetically sealing the covered cans;
retorting the sealed cans; and
cooling the retorted cans to ambient temperature.
